(19) United States
(12) Patent Application Publication
(10) Pub. No.: US 2013/0094742 A1
(43) Pub. Date: Apr. 18, 2013

(54) METHOD AND SYSTEM FOR DETERMINING AN IMAGING DIRECTION AND CALIBRATION OF AN IMAGING APPARATUS

(71) Applicant: Thomas Feilkas, Feldkirchen (DE)

(72) Inventor: Thomas Feilkas, Feldkirchen (DE)

(21) Appl. No.: 13/806,230

(22) PCT Filed: Jul. 14, 2010
(86) PCT No.: PCT/EP2010/060136

§ 371 Date: Dec. 21, 2012

(51) Int. Cl. G06T 7/00

(52) U.S. Cl. CPC G06T 7/0014
USPC 382/131

(57) ABSTRACT

The present invention relates to a method for determining an imaging direction of an imaging apparatus (10), such as an x-ray apparatus, with a radiation source or an imaging source (12) that emits an imaging beam (14) to an imaging detector (16) along a beam path, comprising the steps of imaging an object (18) from a first direction to obtain a first 2D image; providing 3D reference data, for example a generic or statistical 3D model or an earlier obtained 3D data set, of the imaged object (18); performing a 2D/3D matching of the first 2D image with the 3D reference data to determine a position of an imaging plane (20, 22, 24) of the first 2D image relative to the 3D reference data; and determining the imaging direction of the imaging apparatus (10) relative to the object (18) based on the position of the imaging plane (20, 22, 24) relative to the 3D reference data, as well as to a navigation system for computer-assisted surgery comprising the imaging system of the preceding claim; a tracking system (11), such as optical or IR tracking means; detection devices (13, 15) such as e.g. radiopaque markers (13) detectable by the imaging system and markers (15) detectable by the tracking system (11) attachable to an object (18), wherein the navigation system is adapted to detect a position of the object (18) based on the detection devices (13, 15), in order to generate detection signals and to supply the detection signals to the computer (17) such that the computer can determine point data on the basis of the detection signals received; a calibration object such as a patient body or a phantom bearing detection devices for calibrating the navigation system.

### FIELD OF THE INVENTION

The present invention relates to a method for determining an imaging direction of an imaging apparatus, such as an x-ray apparatus, to a method for calibrating a 2D imaging apparatus, to a related program, program storage medium, imaging system and navigation system.

### BACKGROUND OF THE INVENTION

In medical imaging, correct representation of imaged tissue structures is of substantial importance for efficient diagnostics or surgical interventions on the basis of the obtained images. Thus, efforts are currently made to correct misrepresentations of the imaged structures, wherein the prevalent medical imaging systems are Ultrasonography, X-ray such as e.g. Fluoroscopy or Computed Tomography, and Magnetic Resonance Imaging.

Some methods for correcting misrepresentations of imaged structures account for deviations of the projection geometry from the actual geometry of the imaging system. For example, mechanical flexure of an X-ray diagnostic machine e.g. due to turning a C-arc may cause such deviations. Therefore, the X-ray imaging systems are usually calibrated with special X-ray phantoms. Usually, a calibration is performed at certain times such as, for example, prior to the start of an imaging operation.

### SUMMARY OF THE INVENTION

It is an object of the invention to provide a fast and user friendly method for determining an imaging direction of an imaging apparatus. Another object of the invention is to provide a reliable method with improved accuracy and simplified handling for calibrating a medical imaging system, as well as to provide an imaging and a navigation system applying or adapted to apply the method for calibrating a medical imaging system.

These objects are solved by the methods and systems as defined in the independent claims. Preferred embodiments are defined in the dependent claims.

According to an aspect of the invention, a method for determining an imaging direction of an imaging apparatus, such as an x-ray apparatus, is suggested. The imaging apparatus can comprise an imaging source that emits an imaging beam to an imaging detector in the beam path, wherein an object such as a patient or a part of a patient's body is positioned in the beam path to be penetrated by the imaging beam to generate imaging data such as a 2D image of the object.

The imaging apparatus can also be an ultrasonography imaging apparatus. In this case, the object can be positioned in the beam path to generate a 2D image of the object from rays reflected by the object.

The imaging beam can subsequently be understood as a bundle of parallel or conical rays, preferably x-rays, or a projection of energy, preferably x-ray energy, radiating from the imaging source. A straight line through the imaging source and the geometric center of the beam can be understood as representing the beam, preferably being the direction or orientation of the beam. After being emitted by the imaging source, the imaging beam propagates along the beam path, penetrates the object and falls on the image detector, which can thus generate an image of the object.

The image detector can be understood as having a plane detecting surface, which is comprised by or is part of an imaging plane. If the image detector has a curved detecting surface, the imaging plane can be understood as either a tangent plane touching the detecting surface, or a plane surface cutting the detecting surface.

The imaging direction can be defined as an orientation or a spatial angle of the imaging beam with respect to the object. In so doing, the position of the beam with respect to the object can preferably be defined as the position of the beam with respect to a reference plane cutting the object, wherein the reference plane can be for example the plane of the 2D image. Preferably, the reference plane can be understood as the plane of a particular, formerly obtained, 2D image, wherein the user may desire to know how much the orientation of the plane of a currently obtained 2D image deviates from the orientation of the plane of a formerly obtained 2D image or how the positional relation of the imaged 3D object and the formerly obtained 2D image was at the time of imaging.

The imaging direction can also be defined as an orientation or a spatial angle of the imaging beam with respect to the imaging apparatus, wherein the imaging apparatus can be represented by the imaging plane. By means of a known geometrical relation between the object and the imaging apparatus, which can be understood as the orientation of the imaging plane with respect to object, especially to the reference plane cutting the object, the spatial angle of the imaging beam with respect to the imaging apparatus determines the spatial angle of the imaging beam with respect to the object.

The imaging plane can be arranged relative to the imaging beam so that imaging aberrations are reduced to a minimum. Preferably, the imaging beam is perpendicular to the imaging plane.

The method comprises the steps of
imaging the object to obtain a first 2D image,
providing 3D reference data of the object,
performing a 2D/3D matching of the first 2D image with the 3D reference data and
determining the imaging direction of the imaging apparatus relative to the object.

Imaging the object to obtain the first 2D image can comprise the steps of irradiating the object with the imaging beam, detecting the rays penetrating the object by the imaging detector and generating the first 2D image by means of the imaging detector as a projected view or projection image of the object onto the imaging plane. The imaging can be performed from a direction identical with a first direction, wherein the first direction can be defined, as described above, with reference to the object or to the imaging apparatus.

Providing 3D reference data can be done for example by providing a generic or statistical 3D model or an earlier obtained 3D data set, preferably obtained in the same modality as the 2D image, of the imaged object. The model can be a 3D surface and/or a volumetric model.

The 2D/3D matching, which can be intensity-based or feature-based, can be performed to determine a position of an imaging plane of the first 2D image relative to the 3D reference data. The 2D/3D matching returns a similarity measure which can be used to select a projected view or image according to an extent of similarity to a given projection of the 3D reference data onto the imaging plane.

Determining the imaging direction of the imaging apparatus relative to the object can be performed based on the position of the imaging plane relative to the 3D reference data. The position of the imaging plane can be expressed in local coordinates defined with respect to the 3D reference data and/or in global coordinates defined preferably with respect to the imaging system. The relation between local and global coordinates can be based on the position of the 3D reference data relative to the imaging system.

Advantageously, the process of determining the imaging direction according to the invention can be performed without using a calibration kit such as a phantom. Thus, the amount of human effort and consequently work time and costs related to this process can be substantially reduced as compared with state of the art processes involving the use of a calibration kit.

The imaging data preferably comprises information concerning an imaging geometry. The information concerning the imaging geometry in particular comprises information concerning the imaging direction. The information concerning the imaging geometry preferably comprises information which allows a 2D image to be calculated, given a known relative location between the imaging apparatus and the object to be analyzed by the imaging radiation and/or waves (in the given case, the patient), if the object to be analyzed is known, wherein “known” means that the spatial shape of the object is known. This in turn means that 3D, “spatially resolved” information concerning the interaction between the object and the analysis radiation and/or waves is known, wherein “interaction” means for example that the analysis radiation and/or waves are blocked or partially or completely allowed to pass by the object. Information concerning this interaction is preferably three-dimensionally known, for example from a three-dimensional CT, and describes the interaction in a spatially resolved way for (in particular all of the) points and/or regions of the analysis object. Knowledge of the imaging geometry in particular allows a location of a source of the radiation (for example, an x-ray source) to be calculated relative to an image plane. With respect to the connection between 3D objects and 2D analysis images, as defined by the imaging geometry, reference is made in particular to the following publications, wherein the entire disclosure of each of the below-listed documents is hereby incorporated by reference herein and made part of this specification:

1. “An Efficient and Accurate Camera Calibration Technique for 3D Machine Vision”, Roger Y. Tsai, Proceedings of IEEE Conference on Computer Vision and Pattern Recognition. Miami Beach, FLUID, 1986, pages 364-374

2. “A Versatile Camera Calibration Technique for High-Accuracy 3D Machine Vision Metrology Using Off-the-Shelf TV Cameras and Lenses”, Roger Y. Tsai, IEEE Journal of Robotics and Automation, Vol. RA-3, No. 4, August 1987, pages 323-344.

3. Publication by Ziv Yaniv, “Fluoroscopic X-ray Image Processing and Registration for Computer-Aided Orthopedic Surgery”

4. EP 08 156 293.6

5. U.S. 61/054,187

In an embodiment, performing a 2D/3D matching between the first 2D image and the 3D reference data can comprise the steps of obtaining a plurality of 2D projections or 2D projected images, which can be understood as 2D simulated images, from the 3D reference data, and selecting from the plurality of 2D projections a first best match projection which best matches the first 2D image. A plurality of 2D projected images is related to a plurality of positions of the imaging plane of the first 2D image relative to the 3D reference data, wherein each 2D projected image is related to a particular position of the imaging plane of the corresponding 2D image relative to the 3D reference data and each position of the imaging plane is different from another position of the imaging plane.

A 2D image obtained by imaging the object with the imaging system can be named as target or sensed image, whereas a 2D simulated image obtained from the 3D reference data can be named as reference or source image. In this terminology, the reference image can be compared to the target image for each point and the best matching views can be selected. The hereby obtained pair of reference image and target image then represent a “best matching set”, which can be re-sampled at a higher resolution and the process can be repeated to convergence. Such a search or optimization is efficient and can be applied additionally or alternatively to a gradient descent search or optimization.

In an embodiment, a 2D12D registration of the first 2D image and the first best match projection can be performed to obtain a transformation matrix or distortion matrix which allows a mapping of the 2D image to the first best match projection. In so doing, image registration can be understood as a process of transforming different sets of data or data such as a target image and a reference image into one coordinate system, wherein image registration is necessary in order to be able to compare or integrate the different sets of data. The distortion matrix accounts for distortions occurring in medical imaging such as artifacts, radial distortion, tangential distortion, or mustache distortion.

The image registration can be an area based image registration or a feature image based registration. For an area based image registration, the algorithm looks at the structure of the image via correlation metrics, Fourier properties and other means of structural analysis. Alternatively, the feature based image registration, instead of looking at the overall structure of the images, fine tunes its mappings to the correlation of image features: lines, curves, points, line intersections, boundaries, etc.

In an embodiment, the 2D/2D registration of the first 2D image and the first best match projection can performed as a rigid registration. A rigid registration includes linear transformations, which are a combination of translation, rotation, global scaling, shear and perspective components. Usually, perspective components are not needed for rigid registration, so that in this case the linear transformation is an affine one. A well known method for rigid registration is the Iterative Closest Point algorithm introduced in P. J. Besl, N. D. McKay: A method for rigid registration of 3-D shapes, IEEE Transactions on Pattern Analysis and Machine Intelligence, 14(2):239-256, 1992.

The 2D/2D registration of the first 2D image and the first best match projection can also be performed as a non-rigid registration or elastic registration. This transformation allows local warping of image features, thus providing support for local deformations. A nonrigid transformation approach includes polynomial wrapping, interpolation of smooth basis functions (thin-plate splines and wavelets), and physical continuum models (viscous fluid models and large deformation diffeomorphisms). A well known method for non-rigid registration is the method of deforming a statistical 3D model to the contours segmented on x-ray views introduced in M. Fleute, S. Lavallee, Nonrigid 3D/2D Registration of Images Using Statistical Models, Lecture Notes in Computer Science, Springer 1999, p. 138-147. The entire disclosure of each of the mentioned documents is hereby incorporated by reference herein and made part of this specification.

In an embodiment, a 2D projection is generated as a Digitally Reconstructed Radiograph (DRR) from the 3D reference data. The 2D projection can preferably be generated by summing the attenuation of each voxel along known ray paths through the data volume.

A DRR can be generated by a ray-casting algorithm, which simulates radiographic image formation by modeling the attenuation that x-rays experience as they pass through an object with a density higher than zero. Rays are constructed between points in the imaging plane and the imaging source. Thus each ray corresponds to a point in the individual image plane and each intensity value in the image plane is computed by integrating (summing) the attenuation coefficient along the corresponding ray. Because the projection rays usually do not coincide with the 3D data set coordinate system, interpolation is required to implement the projection and the chosen interpolation scheme determines the resulting accuracy of the generated projection. This method can be understood as volume rendering. When computing the projection image, the DRR is generated by accumulating the image plane projections for each voxel in the volume data set.

In an embodiment, landmarks such as singular structural points of the object or fiducial markers attached to the surface or skin of the object or implanted in the object can be used for the rigid or non-rigid 2D/2D registration. This step can be viewed in the context of understanding the determination of aforementioned “best matching set” as a 3D/2D registration of the 3D reference data and the first 2D image.

Herein, the calculation of the transformation necessary to register the two coordinate systems can be simplified or accelerated by use of the knowledge of the position of at least one, preferably at least three, reference points in each coordinate system. Such a rigid or non-rigid registration can be performed as a feature-based approach. Contour- and point-based techniques are examples of this approach. Here, the reduced number of features to be registered can provide computational speedup.

The n-dimensional image of the body is registered when the spatial location of each point of an actual object within a space, for example a body part in an operating theatre, is assigned an image data point of an image (CT, MR, . . . ) stored in a navigation system.

The reference points are used to correlate the first target image or target space to the first reference image or reference space by aligning the corresponding reference points in both spaces. The reference points can be anatomic landmarks such as singular structural points of the object, for example a specified bony structure, the tip of the nose, the nasion, or the ear opening. The reference points can also be fiducials preferably implemented as geometric centers of markers called fiducial markers attached to the surface or skin of the object or implanted in the object.

A landmark can be a defined position of an anatomical characteristic of an anatomical body part which is always identical or recurs with a high degree of similarity in the same anatomical body part of multiple patients. Typical landmarks are for example the epicondyles of a femoral bone or the tips of the transverse processes and/or dorsal process of a vertebra. The points (main points or auxiliary points) can represent such landmarks. A landmark which lies on (in particular on the surface of) a characteristic anatomical structure of the body part can also represent said structure. The landmark can represent the anatomical structure or only a point or part of it. For instance, a landmark can also lie on the anatomical structure which is in particular a prominent structure. An example of such an anatomical structure is the posterior aspect of the iliac crest. Other landmarks include a landmark defined by the rim of the acetabulum, for instance by the centre of the rim. In another example, a landmark represents the bottom or deepest point of an acetabulum, which is derived from a multitude of detection points. Thus, one landmark can in particular represent a multitude of detection points. As mentioned above, a landmark can represent an anatomical characteristic which is defined on the basis of a characteristic structure of the body part. Additionally, a landmark can also represent an anatomical characteristic defined by a relative movement of two body parts, such as the rotational centre of the femur when moved relative to the acetabulum.

In an embodiment, the 2D/2D registration of the first 2D image and the first best match projection of the 3D reference data is performed as a multi-modality registration, wherein the 3D reference data is obtained with a different imaging modality than the 2D images. For example, 3D CT reference data and 2D X-ray images can be fused, the primary focus being on registering bony structures, since both modalities best visualize such information. 3D MRT reference data and 2D X-ray images can also be fused, wherein the differences in the sensing principles of both data acquisition processes must be taken into account.

According to another aspect of the invention, a method for calibrating a 2D imaging apparatus, such as an x-ray apparatus, is suggested. The method comprises the steps of:
imaging an object from a first direction;
determining a first transformation matrix; and
determining first image calibration parameters of the imaging apparatus.

The initial step of the method, concerned with imaging the object from the first direction, is performed to determine an imaging direction of the imaging apparatus relative to the object. The imaging direction is determined by a procedure for determining an imaging direction of an imaging apparatus as described before which comprises the steps of irradiating the object with an imaging beam, detecting the rays penetrating the object by the imaging detector and generating the first 2D image by means of the imaging detector as a projected view or projection image of the object onto the imaging plane.

The following step of the method, concerned with determining a first transformation matrix, is performed to establish a relation between the first best match projection, best matching the first 2D image, and the first 2D image. The best match projection is related to the first imaging direction of the imaging apparatus in a way defined by the first transformation matrix, which can be obtained from the registration parameters as a relation between the first best match projection and first 2D image when mapping the first best match projection to the first 2D image, by applying a rigid and/or non-rigid registration.

The subsequent step of the method, concerned with determining the first image calibration parameters of the imaging apparatus, is performed to compensate an imaging distortion of the imaging apparatus by means of the first image calibration parameters, which are obtained from the first transformation matrix.

Advantageously, the calibrating process of the imaging apparatus according to the invention can be performed without using a calibration kit such as a phantom. Thus, the amount of human effort and consequently work time and costs related to this process can be substantially reduced as compared with state of the art processes involving the use of a calibration kit. The accuracy of the results is steadily high, since any human intervention directly related to the calibration process is not necessary. In other words, it is not necessary to have a human operator taking care of replicating working conditions applied in the calibration process, during normal operation, i.e. regular imaging applied in daily medical practice, as could be necessary for example when using a calibration kit.

In an embodiment, the first image calibration parameters of the imaging apparatus can be determined as an inverse matrix of the first transformation matrix, which mathematically can be expressed as a linear or non-linear mapping operator mapping the first target image to the first reference image. If the mapping is performed by a non-linear processing such as a non-rigid registration, the first transformation matrix can especially be obtained by linearising the non-linear mapping operator in one or several operating points. In the case of non-linear mapping the matrix can also be obtained from differential equations governing the mapping relation, especially by linearising the equations in one or several operating points.

In an optional embodiment, the image calibration parameters are stored in data storage to equalize or compensate subsequently acquired 2D images of the object.

Advantageously, the image calibration parameters can be obtained during regular operation of the imaging apparatus. A separate calibration procedure is not needed. The regular operation of the imaging apparatus can subsequently be understood as an operation of the imaging apparatus with a diagnostic or therapeutic purpose. Immediately after obtaining the image calibration parameters, the measured 2D image can be corrected or distorted by applying the image calibration parameters to the measured 2D image.

In an embodiment, interpolation parameters for transformation matrices can be determined to take into account that imaging parameters and implicitly transformation matrices can vary with the imaging direction. This means, a first transformation matrix corresponding to a first imaging direction can differ from a second transformation matrix corresponding to a second imaging direction, if the first and second imaging directions are not identical. Therefore, rigid or non-rigid registrations of 2D images obtained from new imaging directions differing from any of the preceding imaging directions may need an adapted or corrected transformation matrix.

Determining the necessary correction can be performed by the use of interpolation parameters, so that a transformation matrix involved in an imaging from a new imaging direction not identical with one of the preceding imaging directions can be obtained by interpolation from known, preceding transformation matrices. For that, supplemental angular measurements can be performed to obtain interpolation parameters for further imaging directions.

Obtaining the interpolation parameters comprises the steps of:
imaging the object from a second direction,
determining a second transformation matrix, and
determining the interpolation parameters.

Imaging the object from a second direction implies determining a second imaging direction of the imaging apparatus relative to the object as described above. The object is positioned in the beam path to be penetrated by the imaging beam to generate imaging data such as a second 2D image of the object. Further on, after providing 3D reference data of the object or, if applicable, of a similar object or a generic object, a 2D/3D matching or registration of the second 2D image and the 3D reference data is performed.

Determining the second transformation matrix establishes a relation between a second best match projection or second target image best matching the second 2D image and the second 2D image or second reference image, wherein the second target image is related to the second imaging direction of the imaging apparatus. The transformation matrix or distortion matrix can be obtained from the parameters of the 2D/3D registration of the second 2D image and the 3D reference data.

The subsequent step refers to the determination of the interpolation parameters for transformation matrices which are associated with further directions between the first and second direction. Determining the interpolation parameters is based on the first transformation matrix corresponding to the first imaging direction and the second transformation matrix corresponding to the second imaging direction.

The procedure of determining the interpolation parameters for transformation matrices can be also applied for several second imaging directions of the imaging apparatus, wherein imaging the object from a plurality of directions to determine a plurality of imaging directions of the imaging apparatus relative to the object is performed. The steps above, applied to determining the first and second transformation matrix, are further applicable to further transformation matrices. In so doing, the angular space of imaging directions is preferably equidistantly sampled.

In an embodiment, interpolation parameters for transformation matrices can be adjusted during regular operation of the imaging apparatus. For this purpose, the object can be imaged from a further direction to determine a transformation matrix of the imaging apparatus related to the new direction. The obtained transformation matrix can be used as an additional set of sampling points for the interpolation parameters of the transformation matrices.

In an embodiment, the correction of a measured 2D image obtained during normal or regular operation of the imaging apparatus can be done in two various ways:

a) performing a 3D/2D registration of the 3D reference data and the 2D image to correct the 2D image, and adjusting the interpolation parameters; or

b) determining an imaging direction of the imaging apparatus relative to the object to facilitate determining image calibration parameters corresponding to the imaging direction from the interpolation parameters, processing the 2D image with the calibration parameters to correct the 2D image, and performing a 3D/2D registration of the 3D reference data and the 2D image to adjust the interpolation parameters.

Option b) has a substantial speed advantage over option a), since no 3D/2D registration, which can be related to a possibly time consuming search or optimization process, has to be performed on-line during regular operation in order to obtain a corrected 2D image. The 3D/2D registration, subsequent to obtaining the corrected 2D image, can be performed off-line, for example during the night, when consideration referring to computing time are of no consequence. Only algebraic calculations have to be applied to the on-line part of the regular operation, to distort the measured 2D image. These operations are related to applying the interpolation parameters to the new imaging direction for obtaining the new calibration parameters and to subsequently apply them to the measured 2D image to distort the image.

Both options a) and b) have a substantial handling advantage over state of the art calibration methods using a calibration kit, since no separate calibration measurements have to be performed.

Thus, in this document, the term “calibration” can be understood as a process, executed during normal, i.e. regular, operation of the imaging apparatus, which comprises
correcting the 2D image obtained with the imaging apparatus, either by a 3D/2D registration of the 3D reference data and the 2D image or by using the interpolation parameters, and
determining the imaging direction of the 2D image to adjust the interpolation parameters,
   wherein both orders of execution of the mentioned steps is possible.

According to another aspect of the invention, a program is suggested which, when running on a computer or when loaded onto a computer, causes the computer to perform the method for calibrating a 2D imaging apparatus. The program can be defined as a calibration program for a 2D imaging apparatus.

The calibration program is related to a computer on which the calibration program is running or into the memory of which the calibration program is loaded, and/or a signal wave, in particular a digital signal wave, carrying information which represents the calibration program, in particular, the aforementioned calibration program comprises code means adapted to perform all the steps of the method for calibrating a 2D imaging apparatus.

According to another aspect of the invention, a program storage medium is suggested on which the calibration program described above is in particular non-transitory stored.

According to another aspect of the invention, an imaging system is suggested. The imaging system comprises:
an imaging apparatus, and
a computer on which the calibration program described above is running or loaded.

The imaging apparatus, preferably an ultrasonography, X-ray, computed tomography, or magnetic resonance imaging apparatus, comprises an imaging source that emits an imaging beam to an imaging detector, for obtaining 2D images of an object.

The computer is operatively coupled to the imaging apparatus to calibrate the imaging apparatus according to the method above for calibrating a 2D imaging apparatus and/or to compensate or equalize subsequently generated 2D images of an object.

According to another aspect of the invention, a navigation system for computer-assisted surgery is suggested. The navigation system comprises:
the imaging system described above,
a tracking system, such as optical or IR tracking means,
detection devices,
a calibration object, and
a user interface.

The detection devices are composed of or comprise:
radiopaque markers detectable by the imaging system,
markers or marker devices or reference stars detectable by the tracking system attachable to an object, and/or
structural items of the object such as landmarks,
   wherein the navigation system is adapted to detect a position of the object based on the detection devices, in order to generate detection signals and to supply the detection signals to the computer such that the computer can determine point data on the basis of the detection signals received. The markers detectable by the imaging system and those detectable by the tracking system are adapted to establish a link between coordinate systems of the imaging system and of the tracking system.

The calibration object can be a patient body or a phantom bearing detection devices for calibrating the navigation system.

The user interface is adapted to inform a user optically and/or acoustically and/or vibrationally about the calculation results obtained from the imaging system. Examples of a user interface are a monitor or a loudspeaker or a vibrations creating motor device.

The navigation system can be used or understood as a planning system permitting the acquisition of images from a multiplicity of angles while traversing the whole body of a patient to produce single, bi-plane, or multi-plane whole body 2D projection images which are utilized to plan subsequent multi-modality imaging procedures. The planning system can be adapted for planning and/or performing an operation.

It is the function of a marker to be detected by a marker detection device (for example, a camera or an ultrasound receiver), such that its spatial position (i.e. its spatial location and/or alignment) can be ascertained. The detection device is in particular part of the navigation system. The markers can be active markers. An active marker can for example emit electromagnetic radiation and/or waves, wherein said radiation can be in the infrared, visible and/or ultraviolet spectral range. The marker can also however be passive, i.e. can for example reflect electromagnetic radiation in the infrared, visible and/or ultraviolet spectral range. To this end, the marker can be provided with a surface which has corresponding reflective properties. It is also possible for a marker to reflect and/or emit electromagnetic radiation and/or waves in the radio frequency range or at ultrasound wavelengths. A marker preferably has a spherical and/or spheroid shape and can therefore be referred to as a marker sphere; markers can also, however, exhibit a cornered—for example, cubic—shape.

A marker device can for example be a reference star or a pointer or one or more (individual) markers in a predetermined spatial relationship. A marker device comprises one, two, three or more markers in a predetermined spatial relationship. This predetermined spatial relationship is in particular known to a navigation system and for example stored in a computer of the navigation system.

A reference star refers to a device with a number of markers, advantageously three markers, attached to it, wherein the markers are (in particular detachably) attached to the reference star such that they are stationary, thus providing a known (and advantageously fixed) position of the markers relative to each other. The position of the markers relative to each other can be individually different for each reference star used within the framework of a navigation method, in order to enable the corresponding reference star to be identified by the navigation system on the basis of the position of the markers relative to each other. It is therefore also then possible for the objects (for example, instruments and/or parts of a body) to which the reference star is attached to be identified and/or differentiated. In a navigation method, the reference star serves to attach a plurality of markers to an object (for example, a bone or a medical instrument) in order to be able to detect the position of the object (i.e. its spatial location and/or alignment). Such a reference star in particular comprises a way of being attached to the object (for example, a clamp and/or a thread) and/or a holding element which ensures a distance between the markers and the object (in particular in order to assist the visibility of the markers to a marker detection device) and/or marker holders which are mechanically connected to the holding element and which the markers can be attached to.

Registration devices such as radiopaque markers detectable by the imaging system to obtain a preoperative 2D image and a reference star detectable by the tracking system during operation can be used connected with a registration procedure in order in particular to register the position of an anatomical part of the body which is of interest in the operation with respect to the reference system of a preoperative 2D image of said part of the body (or vice versa). The registration devices are imaged together with the body or body portion, and the images of said registration devices are then used to register the patient with his image by assigning them to their real spatial positions or equivalents.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 illustrates the adjusting of a C-arc to obtain several x-ray images for the calibration of the x-ray imaging system;

FIGS. 2A-2C illustrate a process of calibrating a 2D imaging apparatus with an x-ray kit; and

FIGS. 3A-3C illustrate a process of calibrating a 2D imaging apparatus with an object.

### DETAILED DESCRIPTION OF THE PREFERRED EMBODIMENTS

Reference will now be made in detail to the exemplary embodiments of the invention illustrated in the accompanying drawings.

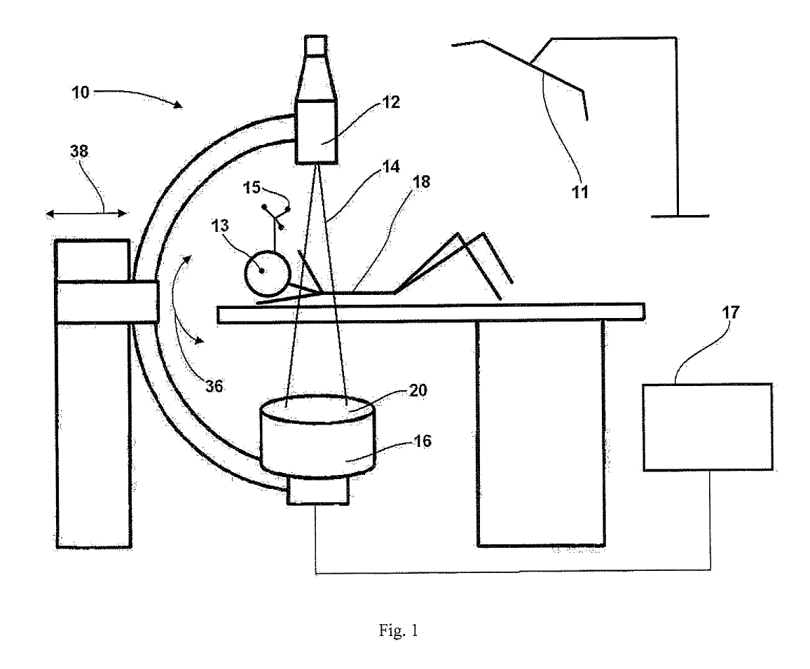

In FIG. 1, the method of determining an imaging direction of an imaging apparatus 10, such as a C-arc, with reference to an object 18, is shown. The imaging apparatus 10 comprises an imaging source 12 that emits an imaging beam 14 to an imaging detector 16 in the beam path. The image detector 16 has a plane detecting surface, which is comprised by or is part of an imaging plane 20. The imaging plane 20 is perpendicular to the imaging beam 14. The spatial positions of both imaging source 12 and imaging detector 16 are variable with reference to the object 18 by adapting the angle of the imaging beam 14 or the shift of the imaging beam 38.

The method comprises the steps of:
imaging the object 18 from a first direction to obtain a first 2D image;
providing 3D reference data, for example a generic or statistical 3D model or an earlier obtained 3D data set, of the imaged object 18;
performing a 2D/3D matching of the first 2D image with the 3D reference data to determine a position of an imaging plane 20 of the first 2D image relative to the 3D reference data; and
determining the imaging direction of the imaging apparatus 10 relative to the object 18 based on the position of the imaging plane 20 relative to the 3D reference data.

Determining the imaging direction of the imaging apparatus 10 relative to the object 18 is performed based on the position of the imaging plane 20 relative to the 3D reference data. Advantageously, determining the imaging direction is performed without using a calibration kit such as a phantom. Thus, the amount of human effort and consequently work time and costs related to this process can be substantially reduced as compared with state of the art processes involving the use of a calibration kit.

The obtained imaging direction is used to enable a simple way of calibrating the imaging apparatus 10 and of correcting the obtained 2D images during normal or regular operation of the imaging apparatus 10. Both calibration and correction can be done in two various ways:
a) performing a 3D/2D registration of the 3D reference data and the 2D image to correct the 2D image, and adjusting the interpolation parameters; or
b) determining an imaging direction of the imaging apparatus relative to the object (18) to facilitate determining image calibration parameters corresponding to the imaging direction from the interpolation parameters, processing the 2D image with the calibration parameters to correct the 2D image, and performing a 3D/2D registration of the 3D reference data and the 2D image to adjust the interpolation parameters.

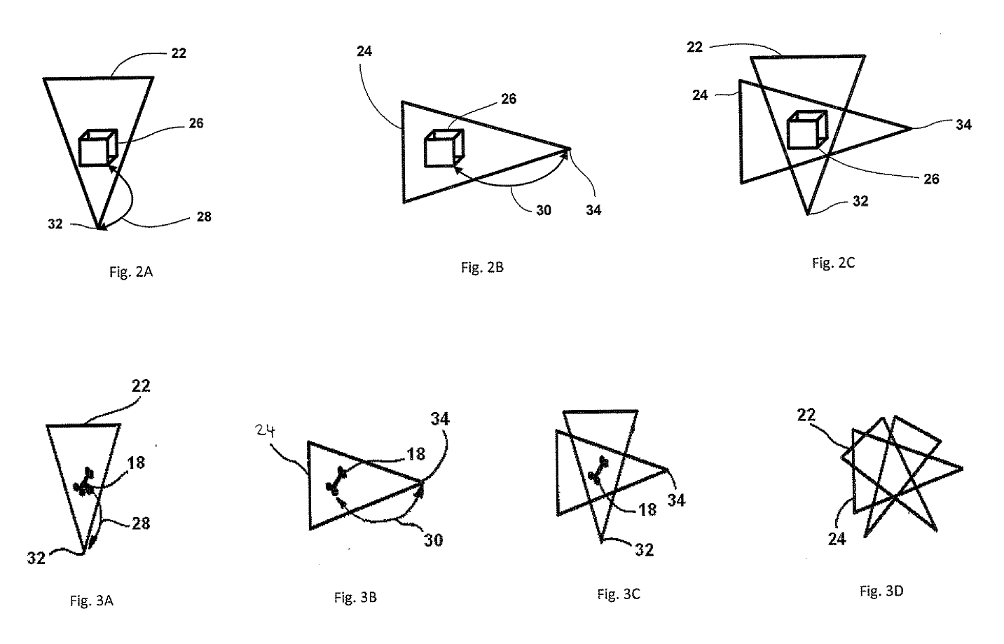

In FIGS. 2A-2C, the process of calibrating a 2D imaging apparatus with a phantom 26 is shown. In the case at issue, the 2D imaging apparatus is a C-Arm or Fluoroscope and the phantom is an x-ray kit 26. The geometry of the phantom 26 is a priori known as 3D reference data such as CAD data.

In FIG. 2A, the x-ray kit 26 is imaged from a first direction or first camera position 32, thus obtaining a first 2D image in a first image plane 22. From registering the first 2D image to the 3D reference data, a first registration matrix 28 or transformation matrix is obtained. The first registration matrix 28 is obtained directly after performing the rigid or non-rigid registration between the 2D image obtained from the phantom and the 3D reference data of the phantom 26. If markers are used to accelerate the registration process, the first registration matrix 28 is obtained after selection of pairs of markers. From the first registration matrix 28, a set of first image calibration parameters are subsequently obtained.

In FIG. 2B, the x-ray kit 26 is imaged from a second direction or second camera position 34, thus obtaining a second 2D image in a second image plane 24. The second imaging direction differs from the first imaging direction used in step A. From registering the second 2D image to the 3D reference data of the object 26, a second registration matrix 30 or transformation matrix is obtained. The process of obtaining the second registration matrix 30 is similar to that of obtaining the first registration matrix 28. From the second registration matrix 30, a set of second image calibration parameters are subsequently obtained.

In FIG. 2C, a summarizing sequence comprising step A and step B is shown, having as a result the first 2D image and the second 2D image, as well as a first and second set of image calibration parameters. Subsequently, the determination of the interpolation parameters for registration matrices which are associated with further directions between the first and second direction is performed. Determining the interpolation parameters is based on the first registration matrix 28 corresponding to the first imaging direction and the second registration matrix 30 corresponding to the second imaging direction.

Nevertheless, the calibration can be performed without any phantom 26 or x-ray kit by replacing the phantom 26 with an arbitrary object 18, non-opaque to the imaging radiation, such as the body of a patient. FIGS. 3A-3D illustrate the process of calibrating a 2D imaging apparatus with such an object 18. Here, the 2D imaging apparatus is also a C-Arm or Fluoroscope.

In FIG. 3A, the object 18 is imaged from a first direction or first camera position 32, thus obtaining a first 2D image in a first image plane 22. From registering the first 2D image to the 3D reference data, a first registration matrix 28 is obtained after performing the rigid or non-rigid registration between the 2D image obtained from the object and the 3D reference data of the object. Reference points such as markers or landmarks are commonly used to correlate the 2D image obtained by the C-Arc, also named as first target image, to a best matching DRR obtained from the 3D data set, also named as first reference image, by aligning the corresponding reference points in both the target image and reference image. From the first registration matrix 28, a set of first image calibration parameters are subsequently obtained.

In FIG. 3B, the object 18 is imaged from a second direction or second camera position 32, thus obtaining a second 2D image in a second image plane 24. The second imaging direction differs from the first imaging direction used in step A. From registering the second 2D image to the 3D reference data, a second registration matrix 30 or transformation matrix is obtained. The process of obtaining the second registration matrix 30 is similar to that of obtaining the first registration matrix 28. From the second registration matrix 30, a set of second image calibration parameters are subsequently obtained.

In FIG. 3C, a summarizing sequence comprising step A and step B is shown, having as a result the first 2D image and the second 2D image, as well as a first and second set of image calibration parameters. Subsequently, the determination of the interpolation parameters for registration matrices which are associated with further directions between the first and second direction is performed. Determining the interpolation parameters is based on the first registration matrix 28 corresponding to the first imaging direction and the second registration matrix 30 corresponding to the second imaging direction.

In FIG. 3D, a symbolic sequence comprising several steps is shown, wherein the object is sampled with images from several imaging directions. The steps applied to determining the second registration matrix 30 are applicable to a third and to further registration matrices. From several interpolation parameters, the interpolation quality for imaging directions used for subsequent imaging differing from the imaging directions used for calibration improves.

The volume reconstruction shown in FIG. 2C may guide as well the statistical problem in the sense of reconstructing a 3D model of the patient. The model can initially be inaccurate, therefore the estimation of 2D image directions can be inaccurate as well. One or several initial guesses can be used to reconstruct a 3D volume as shown in FIG. 2C.

The model of the object 18 can comprise structural elements described by strong shape gradients such as contours, which are expected to appear in certain regions or areas of the volume. If the estimation obtained from 2D images has errors, the contours can be washed out or noisy or superposed with noise. The extent of noise or distortion can be an indicator whether the estimation is OK.

The 3D reconstruction shows the real surface of the object in 3D. The 2D images can represent well only parts of the volume, while other parts need to be estimated. The volume reconstruction can also reveal parts of the object 18 primarily not visible in the 2D images.

### LIST OF REFERENCE SIGNS

10 imaging apparatus, x-ray apparatus, C-arc
11 tracking system, IR tracking means, IR camera
12 imaging source
13 radiopaque marker
14 imaging beam
15 marker detectable by the tracking system
16 imaging detector
17 computer
18 object, patient
20 imaging plane
22 first imaging plane
24 second imaging plane
26 phantom, x-ray kit
28 first transformation matrix
30 second transformation matrix
32 first camera position
34 second camera position
36 angle of the imaging beam
38 shift of the imaging beam

1. Method for determining an imaging direction of an imaging apparatus, such as an x-ray apparatus, with a radiation source or an imaging source that emits an imaging beam to an imaging detector along a beam path, comprising the steps of:
imaging an object from a first direction to obtain a first 2D image;
providing 3D reference data, for example a generic or statistical 3D model or an earlier obtained 3D data set, of the imaged object;
performing a 2D/3D matching of the first 2D image with the 3D reference data to determine a position of an imaging plane of the first 2D image relative to the 3D reference data; and
determining the imaging direction of the imaging apparatus relative to the object based on the position of the imaging plane relative to the 3D reference data.

2. Method according to claim 1, further comprising the steps of:
obtaining or generating a plurality of preferably virtual 2D projections from the 3D reference data; and
selecting from the plurality of 2D projections a first best match projection which best matches the imaged first 2D image.

3. Method according to claim 2, further comprising the step of:
performing a 2D/2D registration of the imaged first 2D image and the first best match projection to obtain a transformation matrix or distortion matrix which allows a mapping of the first 2D image to the first best match projection.

4. Method according to claim 3, further comprising the step of:
performing the 2D/2D registration of the first 2D image and the first best match projection as a rigid and/or non-rigid registration.

5. Method according to claim 2, further comprising the step of:
generating 2D projections as Digitally Reconstructed Radiographs (DRRs) from the 3D reference data.

6. Method according to claim 2, further comprising the steps of:
using landmarks such as singular structural points of the object or fiducial markers attached to the surface or skin of the object or implanted in the object for the 2D/2D registration; and/or
performing the 2D/2D registration of the first 2D image and the first best match projection of the 3D reference data as a multi-modality registration, wherein the 3D reference data is obtained with a different imaging modality than the first 2D image.

7. Method for calibrating a 2D imaging apparatus, such as an x-ray apparatus, comprising the steps of:
imaging an object from a first direction and determining an imaging direction of the imaging apparatus relative to the object according to claim 1;
determining a first transformation matrix between the first best match projection which best matches the first 2D image, and the first 2D image, the first best match projection obtained from the 3D reference data being related to or taken from the first imaging direction of the imaging apparatus; and
determining first image calibration parameters of the imaging apparatus from the first transformation matrix to compensate an imaging distortion of the imaging apparatus.

8. Method according to claim 7, further comprising the step of:
determining the first image calibration parameters of the imaging apparatus as an inverse matrix of the first transformation matrix.

9. Method according to claim 7, further comprising the steps of:
imaging the object from a second direction and determining a second imaging direction of the imaging apparatus relative to the object according to claim 1;
determining a second transformation matrix between a second best match projection which best matches the second 2D image, and the second 2D image, the second best match projection obtained from the 3D reference data being related to or taken from the second imaging direction of the imaging apparatus; and
determining interpolation parameters for transformation matrices, associated with further directions between the first and second direction, based on the first transformation matrix corresponding to the first imaging direction and the second transformation matrix corresponding to the second imaging direction.

10. Method according to claim 7, further comprising the steps of:
adjusting the interpolation parameters by imaging the object from a further direction and determining a further imaging direction of the imaging apparatus.

11. Method according to claim 7, wherein after imaging the object to obtain a 2D image the following steps are executed:
determining an imaging direction of the imaging apparatus relative to the object to determine image the calibration parameters calculated or predetermined for the imaging direction;
processing the 2D image with the calibration parameters to correct the 2D image.

12. Program which, when running on a computer or when loaded onto a computer, causes the computer to perform the method according to claim 7.

13. Program storage medium on which the program of claim 12 is in particular non-transitory stored.

14. Imaging system comprising:
an imaging apparatus, such as an x-ray apparatus, with an imaging source that emits an imaging beam to an imaging detector, for obtaining 2D images of an object; and
a computer on which the program of claim 12 is running or loaded, the computer being operatively coupled to the imaging apparatus to calibrate the imaging apparatus according to claim 7 and/or to compensate or equalize subsequently generated 2D images of an object.

15. Navigation system for computer-assisted surgery comprising:
the imaging system of claim 14.
a tracking system, such as optical or IR tracking means;
detection devices such as e.g. radiopaque markers detectable by the imaging system and markers detectable by the tracking system attachable to an object, wherein the navigation system is adapted to detect a position of the object based on the detection devices, in order to generate detection signals and to supply the detection signals to the computer such that the computer can determine point data on the basis of the detection signals received;
a calibration object such as a patient body or a phantom bearing detection devices for calibrating the navigation system.
